(19) United States
(12) Patent Application Publication
(10) Pub. No.: US 2019/0300432 A1
(43) Pub. Date: Oct. 3, 2019

(54) Use of cellulose ether compounds for increasing the open time and improving the wettability of cement-based mortars

(71) Applicant: SE Tylose GmbH & Co. KG, Wiesbaden (DE)

(72) Inventors: Heiner KLEHR, Mainz (DE); Uwe BARTZ, Ingelheim (DE); Harald KEMPF, Dreikirchen (DE)

(21) Appl. No.: 16/365,878

(22) Filed: Mar. 27, 2019

(30) Foreign Application Priority Data
Mar. 29, 2018 (DE) 10 2018 107 556.1

(51) Int. Cl. C04B 24/38; C04B 28/02; C04B 24/08; C04B 20/10; C04B 24/26; C04B 40/00

(52) U.S. Cl. CPC C04B 24/383; C04B 28/02; C04B 24/08; C04B 2103/50; C04B 24/2652; C04B 40/0042; C04B 20/1025

(57) ABSTRACT

The present invention relates to cellulose ether compounds for increasing the open time and improving the wettability of cement-based mortars. The inventive cellulose ether compounds are formed from cellulose ether with one or more liquid antifoams incorporated therein. The inventive cellulose ether compounds are preferably used as modified cellulose ether in dry mortars for increasing the open time.

### CROSS-REFERENCE TO RELATED APPLICATIONS

This application claims priority to German Patent Application 10 2018 107 556.1 filed Mar. 29, 2018, which is hereby incorporated herein by reference in its entirety.

### FIELD OF THE INVENTION

The invention relates to the use of water-soluble cellulose ethers into which one or more liquid antifoams have been incorporated.

### BACKGROUND OF THE INVENTION

Cement-based adhesives, plasters and renders, knifing fillers or composite thermal insulation systems, inter alia, are used for joining or coating components in the building industry. These systems are mixtures of one or more binders (e.g. cement, hydrated lime), fillers (e.g. sands having various particle sizes) and other additives such as cellulose ethers, air pore formers, dispersion powders and starches and starch derivatives such as starch ethers. They are produced in the factory, so that they only have to be mixed with water for processing. These building materials are referred to as factory dry mortars.

Applying tile adhesives based on cement mortars by the thin bed method is prior art. This requires a flat substrate onto which the adhesive is applied in a uniform layer thickness using a toothed spatula. The tiles are laid with their full area and aligned in the adhesive mortar which has been applied in this way. To be able to work very rationally and efficiently, it is an objective of the processor to prepare a very large area with tile adhesive and then lay the tiles into this. For this purpose, the adhesive has to have a sufficiently long open time in order to ensure that all tiles are wetted very completely and over their full area with the adhesive mortar. Thin bed adhesives consist of cement, sand, ground rock and cellulose ethers. Further additives such as dispersion powders, cement accelerators, starch derivatives, inorganic thickeners and fibres can likewise be present in order to optimise the processing properties and solidified mortar properties.

The open time of tile adhesives is determined in accordance with ISO 13007 or EN 1346 by means of adhesive pull strength values after defined laying times. In parallel, so-called wetting tests in which absorptive tiles are, likewise after defined times, laid in the mortar bed and the percentage of wetting is then evaluated are frequently also carried out. The open time is dependent, inter alia, on the water content of the adhesive. The open time is often shortened by undesirable skin formation on the surface of the mortars, which prevents satisfactory wetting of the tiles even though the adhesive is still soft in the interior. High-quality tile adhesives have an open time of at least 30 minutes.

To improve energy efficiency, buildings are often clad with so-called composite thermal insulation systems (CTIS). For this purpose, an insulation board consisting of EPS, XPS, PU, mineral wool, etc. is adhesively bonded to the wall and possibly also fastened by means of dowels. The surface of the insulation board is coated with a base render in which a reinforcing mesh is embedded. Here too, it is important that the base render has a long processing open time so that very large mesh areas can be embedded in the base render and fully wetted in one operation. The base render consists of cement, sand, cellulose ethers and dispersion powders. In addition, starches and starch derivatives such as starch ethers, fibres and further additives can also be present.

EP 2 966 049 A1 discloses a thickener for a hydraulic composition. It comprises a water-soluble cellulose ether, an antifoam, a biopolymer and optionally a water-reducing agent. The cellulose ether is preferably methyl cellulose, ethyl cellulose, hydroxyalkyi cellulose such as hydroxyethyl cellulose or hydroxypropyl cellulose or an alkyl hydroxyalkyl cellulose such as methyl hydroxyethyl cellulose or methyl hydroxypropyl cellulose. Polyoxyalkylenes, silicone oils and agents based on alcohols, on fatty acids or on fatty acid esters are mentioned as antifoams. The biopolymer serves to stabilise the water-soluble cellulose ether in the water-reducing agent. Preference is given to xanthan gum, diutan gum, welan gum and/or gellan gum. The water-reducing agent is preferably a polycarboxylic acid derivative, a lignin derivative or a melamine derivative, for example copolymers of acrylic acid, methacrylic acid, crotonic acid, itaconic acid or citraconic acid with polyalkylene glycol mono(meth)acrylate, styrene, melamine/sulfonic acid/formaldehyde condensates or a ligninosulfonic acid salt.

EP 1 884 503 B1 relates to a hydraulic composition for renders or mortars, which contains cement and/or gypsum plaster, an anionic surfactant having the ability to foam, a nonionic surfactant having the ability to reduce foaming and a water-soluble cellulose ether. The surfactant acting as antifoam is preferably a polyether surfactant, a silicone surfactant, an alcohol surfactant, a mineral oil surfactant or a vegetable oil surfactant.

EP 2 363 428 A1 discloses a composition which serves to modify the rheological properties of cement-based mixtures. It comprises a polysaccharide derivative, in particular a cellulose ether, a siloxane and an antifoam which is not a siloxane. The antifoam is preferably pulverulent. Tributyl phosphate and metal salts of stearic acid are mentioned as pulverulent antifoams. Liquid antifoams such as polyoxyalkylene glycols or oily hydrocarbons should be bound to a solid support material such as diatomaceous earth, silica or calcium silicate.

EP 2 190 800 B1 discloses the use of quaternary organic ammonium compounds in building compositions in order to reduce efflorescence. The ammonia compounds are preferably mixed with cellulose ethers. For this purpose, a liquid and/or dissolved quaternary ammonium compound is sprayed onto the cellulose ether and mixed therewith.

EP 1 426 349 A1 discloses an additive for cement-based compositions. It comprises a copolymer having a plurality of carboxyl groups or a salt thereof, a water-soluble cellulose ether and a solid or liquid antifoam. The additive serves to improve the processability of the cement-based composition and to reduce splashing in the case of spray concrete. In addition, it prevents bleeding of the composition after it has been installed.

Using antifoams (usually pulverulent antifoams) in building materials such as concretes or floor screed compositions is prior art. The objective here is to reduce the air pore content in order to thereby achieve greater strengths and smoother surfaces. Mineral oils (liquid antifoams) are also used in dry mortars, usually in cement-based tile adhesives, grouts and levelling compositions in order to achieve a significant reduction in dust formation during transfer and mixing with water. They are not used as antifoams and also do not have a foam-reducing effect on dry mortar.

When antifoams are used in cement-based tile adhesives or CTIS renders, the foam formation in the mortar is steadily decreased over time: no steady state is attained. The fresh mortar bulk density is about 1.5 kg/i in the case of cement tile adhesives. When antifoams are added, the fresh mortar bulk density increases to 2.0 kg/I after 2 hours. Ever larger air bubbles are formed as time goes on. The higher the fresh mortar bulk density, the harder a cement tile adhesive is to process. Liquid antifoams are usually employed in aqueous coatings such as building paints, gloss paints, tinting paints, wood varnishes, paste-like renders and also in adhesives, concretes, fibrocement sheets, in agricultural, the paper industry, biotechnology, the food industry and in chemical processes. Liquid antifoams are not recommended for dry mortars and are consequently also not used.

### SUMMARY OF ADVANTAGEOUS EMBODIMENTS OF THE INVENTION

It was an object of the invention to develop an antifoamed cellulose ether which has an antifoaming effect for only a limited time. Mortars which contain this antifoamed cellulose ether should be able to be processed readily over a very long period of time.

### BRIEF DESCRIPTION OF THE DRAWINGS

FIG. 1 is a photographic illustration of exemplary results from wetting testing; and

FIG. 2 is a photographic illustration of exemplary results from adhesion and pullout testing.

### DETAILED DESCRIPTION OF ADVANTAGEOUS EMBODIMENTS OF THE INVENTION

It has surprisingly been found that liquid antifoams, in particular fatty acid esters and fatty alcohol alkoxylates, have a temporally limited antifoaming effect combined with good processability of the mortar. A natural biopolymer as additional constituent, as described in EP 2 966 049, is not necessary to achieve this effect. It has likewise been found that these liquid antifoams have to be incorporated into the cellulose ether. A mixture of a cellulose ether and a pulverulent antifoam (or a liquid antifoam on a solid inorganic support) surprisingly does not work. The same applies to the quaternary ammonium compounds mentioned in EP 2 190 800 B1.

The compound according to the invention of a cellulose ether with a liquid antifoam additionally improves wetting significantly and increases the open time in cement tile adhesives, renders and CTIS reinforcing renders. The adhesive pull strengths of tile adhesives after various types of storage (dry, wet, hot, freeze/thaw in accordance with ISO 13007 or EN 1348) are also significantly improved by means of the compound according to the invention.

The cellulose ether compound with liquid antifoam is produced by mixing a cellulose ether with water until it has a moisture content of 60-90%. The liquid antifoam is incorporated or kneaded into this moist cellulose ether. This dough is then dried and milled or mill-dried in one process, as is customary in the industrial production of cellulose ethers. Spraying of liquid antifoams onto the dry cellulose ether is also a possible way of incorporating the antifoam. In the context of the present invention, the term “liquid” refers to antifoams which have a viscosity of less than 250 mPa s, preferably less than 150 mPa s, measured using a Brookfield CAP 2000+, Spindle 01, 250 rpm, 25° C. (DIN EN ISO 321). The resulting compound according to the invention is present as free-flowing powder.

The cellulose ether can be an ionic cellulose ether such as carboxymethyl cellulose (CMC), carboxymethyl hydroxyethyl cellulose (CMHEC), carboxymethyl hydroxypropyl cellulose (CMHPC), sulfoethyl methyl hydroxyethyl cellulose (SEMHEC), sulfoethyl methyl hydroxypropyl cellulose (SEMHPC) or a nonionic cellulose ether such as hydroxyethyl cellulose (HEC), hydroxypropyl cellulose (HPC), methyl cellulose (MC), methyl hydroxypropyl cellulose (MHPC), methyl hydroxyethyl cellulose (MHEC), ethyl hydroxyethyl cellulose (EHEC) or methyl ethyl hydroxyethyl cellulose (MEHEC).

The antifoam is a compound based on oxyalkylene, silicone oil, alcohol, mineral oil, fatty acids and fatty acid esters, with preference being given to fatty acid esters.

Preferred fields of use of the inventive cellulose ether compound with antifoam are: tile adhesives based on cement, for improving the open time and wetting, renders in composite thermal insulation systems and also cement renders (base renders, decor renders, single-coat renders) for increasing the processing time.

The proportion of cellulose ether is generally from about 80 to 99.5% by weight, preferably from about 85 to 98% by weight, particularly preferably from about 90 to 97% by weight, in each case based on the total weight of the dry compound.

The proportion of antifoam is from about 0.5 to 20% by weight, preferably from about 2 to 15% by weight, particularly preferably from about 3 to 10% by weight, in each case based on the total weight of the dry compound.

Cellulose ethers are referred to as water-soluble when at least 2 g thereof can be dissolved in one litre of cold water (20° C.).

Preferred cellulose ethers are:

Methyl cellulose (MC) having a DS_{methyl} of from 1.4 to 2.2, in particular having a DS_{methyl} of from 1.6 to 2.0; methyl hydroxypropyl cellulose (MHPC) having a DS_{methyl} of from 1.2 to 2.2 and an MS_{hydroxypropyl} Of from 0.1 to 1.0, in particular having a DS_{methyl} of from 1.3 to 2.0 and an MS_{hydroxypropyl} of from 0.15 to 0.7; methyl hydroxyethyl cellulose (MHEC) having a DS_{methyl} of from 1.2 to 2.2 and an MS_{hydroxyethyl} of from 0.05 to 0.4, in particular having a DS_{methyl} of from 1.4 to 1.9 and an MS_{hydroxyethyl} of from 0.1 to 0.35; hydroxyethyl cellulose (HEC) having an MS_{hydroxyethyl} of from 1.2 to 4.0, particularly preferably having an MS_{hydroxyethyl} of from 1.6 to 3.5; ethyl hydroxyethyl cellulose (EHEC) having a DS_{ethyl} of from 0.5 to 1.5 and an MS_{hydroxyethyl} of from 1.5 to 3.5 and methyl ethyl hydroxyethyl cellulose (MEHEC) having a DS_{methyl} of from 0.2 to 2.0, a DS_{ethyl} of from 0.05 to 1.5 and an MS_{hydroxyethyl} of from 0.2 to 3.5, carboxymethyl cellulose ether (CMC) having a DS_{carboxymethyl} of from 0.4 to 1.0, carboxymethyl hydroxyethyl cellulose ether (CMHEC) having a DS_{carboxymnethyl} of from 0.1 to 1.0 and an MS_{hydroxyethyl} of from 0.8 to 3.5, carboxymethyl hydroxypropyl cellulose ether (CMHPC) having a DS_{carboxymethyl} of from 0.1 to 1.0 and an MS_{hydroxypropyl} of from 0.8 to 3.3, sulfoethyl methyl hydroxyethyl cellulose ether (SEMHEC) having a DS_{sulfoethyl} of from 0.005 to 0.01, DS_{methyl} of from 0.2 to 2.0 and an MS_{hydroxyethyl} of from 0.1 to 0.3, sulfoethyl methyl hydroxypropyl cellulose ether (SEMHPC) having a DS_{sulfoethyl} of from 0.005 to 0.01, DS_{ethyl} of from 0.2 to 2.0 and an MS_{hydroxypropyl} of from 0.1 to 0.3.

The average degree of polymerization DPw of the cellulose ethers, measured in accordance with Pulps—Determination of Limiting Viscosity Number in Cupriethylenediamine (CED) Solution—in accordance with ISO 5351, is from about 10 to 5000.

The viscosity of the cellulose ethers is from 1 to 20 000 mPa s, preferably from 100 to 15 000 mPa s, particularly preferably from 1000 to 12 000 mPa s. It is measured using a Brookfield RV, 20 rpm, in water of 20° C. and 20° dH. Depending on the viscosity, measurements are carried out at different concentrations of the cellulose ethers: viscosity <150 mPa s: 4.75% by weight absolutely dry (“atro”); viscosity from 150 to 250 mPa s: 2.85% by weight atro; viscosity from 250 to 34 000 mPa s: 1.9% by weight atro; viscosity from 4000 to 20 000 mPa s: 1.0% by weight atro.

The antifoams can be based on oxyalkylene, silicone, alcohol, mineral oil, fatty acids, fatty alcohol alkoxylate and fatty acid esters. Preference is given to fatty alcohol alkoxylate and fatty acid ester antifoams, particularly those which contain a proportion of fatty acid ester, or mixtures of these constituents.

The cellulose ether/antifoam compounds of the invention do not contain any natural biopolymer, in contrast to EP 2 966 049 A1. They also do not contain any quaternary ammonium compounds as disclosed in EP 2 190 800 B1.

The following examples serve to illustrate the invention. Percentages are percentages by weight, unless indicated otherwise or obvious from the context, with “atro” referring to “absolutely dry” and “lutro” referring to “air dry”. The following components were used in the examples:

Cellulose Ethers (CE):

CE1: MHEC, DS 1.7, MS 0.2, viscosity (1.9% atro, 20° C., 20° dH, Brookfield RV 20 rpm, spindle 6) 13 000 mPa s

Fine powder (air jet sieve, <0.125 mm: 95%, <0.063 mm: 50%)

CE2: MHEC, DS 1.7, MS 0.2, viscosity (1.9% atro, 20° C., 20° dH, Brookfield RV 20 rpm, spindle 6) 25 000 mPa s

Fine powder (air jet sieve, <0.125 mm: 95%, <0.063 mm: 50%)

CE3: MHEC, DS 1.7, MS 0.2, viscosity (1.0% atro, 20° C., 20° dH, Brookfield RV 20 rpm, spindle 5) 10 000 mPa s,

Superfine powder (air jet sieve, <0.100 mm: 95%, <0.063 mm: 75%)

CE4: MHEC, DS 1.6, MS 0.3, viscosity (1.9% atro, 20° C., 20° dH, Brookfield RV 20 rpm, spindle 6) 25 000 mPa s

Fine powder (air jet sieve, <0.125 mm: 95%, <0.063 mm: 50%)

CE5: MHPC, DS 1.7, MS 0.2, viscosity (1.9% atro, 20° C., 20° dH, Brookfield RV 20 rpm, spindle 6) 25 000 mPa s

Fine powder (air jet sieve, <0.125 mm: 95%, <0.063 mm: 50%)

Starch Ethers:

SE1: Hydroxypropyl starch (HPS), MS 0.4, viscosity (5% lutro, 20° C., water with about 18° dH, Brookfield RV, 100 rpm, spindle 3) 150-300 mPa s

Modification:

The CEs used in the compound according to the invention are preferably modified CEs. The modifying agents are usually polyacrylamides (PAA). The polyacrylamides are preferably anionic PAAs having a molar mass of more than 10 million.

Antifoams:

E1: Fatty acid ester, density at 20° C.: 900 kg/m³±100 kg/m³; dyn. viscosity at 25° C.: 80 mPa s±30 mPa s; acid number: 35 mg KOH/g±10 mg KOH/q; liquid

E2: 50% by weight of E1 on an inorganic support; powder

E3: Fatty alcohol alkoxylate, density at 20° C.: 950 kg/m³±50 kg/m³, viscosity at 25° C.: 115 mPa s±10 mPa s; liquid

Test Products

TABLE 1
Compositions of the test products (parts by weight)

| | Product No. | | | | | | | | | |
|---|---|---|---|---|---|---|---|---|---|---|
| | 1 | 2 | 3 | 4 | 5 | 6 | 7 | 8 | 9 | 10 |
| CE 1 | | | | | | | | | | |
| CE 2 | 100 | 95 | 88 | 83 | 86 | | | | | 83 |
| CE 3 | | | | | | | | | | |
| CE 4 | | | | | | 88 | 83 | | | |
| CE 5 | | | | | | | | 88 | 83 | |
| PAA | | | 12 | 12 | 12 | 12 | 12 | 12 | 12 | 12 |
| E 1 | | 5 | | 5 | 2 | | 5 | | 5 | |
| E 2 | | | | | | | | | | |
| E 3 | | | | | | | | | | 5 |
| | Product No. | | | | | | | | | |
| | 11 | 12 | 13 | 14 | 15 | 16 | 17 | 18 | 19 | 20 |
| CE 1 | 90 | 88.8 | | | 98.8 | 93.8 | | | | |
| CE 2 | | | | | | | | | | 78 |
| CE 3 | | | 97 | 95 | | | | 87 | 92 | |
| CE 4 | | | | | | | 78 | | | |
| CE 5 | | | | | | | | | | |
| PAA | 10 | 10 | 3 | 3 | 1.2 | 1.2 | 12 | 3 | 3 | 12 |
| E 1 | | 1.2 | | 2 | | 5 | | | 5 | |
| E 2 | | | | | | | 10 | 10 | | 10 |
| E 3 | | | | | | | | | | |

Comparative Products, Commercial Products, which are Recommended for the Application

Manufacturer: Dow Chemical Company

METHOCEL® 327: MHPC, modified, Brookfield viscosity 2% in water at 20° C. and 20 rpm: 22 000 mPa s, fineness <212 μm: min 95%

WALOCEL® MKX 45000 PF 20 L: MHEC, modified, Haake ROTOVISKO® RV 100 viscosity 2% in water at 20° C. and shear rate of 2.55 l/s: 45 000 mPa s

WALOCEL® Xact 13-70-E: MHEC, modified, Haake ROTOVISKO® RV 100 viscosity 2% in water at 20° C. and a shear rate of 2.55 l/s: 13 000 mPa s

WALOCEL® Xact 12-01-E: MHEC, unmodified, Haake ROTOVISKO® RV 100 viscosity 2% in water at 20° C. and a shear rate of 2.55 l/s: 12 000 mPa s

Manufacturer: Ashland

CULMINAL® MHPC 20000 S: MHPC, unmodified, Brookfield RVT viscosity abs. dry, 2% in water at 20° C. and 20 rpm: 15 000 mPa s

CULMINAL® Plus 2060 PF: MHEC, modified, Brookfield RVT viscosity abs. dry, 2% in water at 20° C. and 20 rpm: 20 000 mPa s

Test Formulations

TABLE 2
Compositions of the test mixtures (parts by weight)

| | Test mixture | | | | | |
|---|---|---|---|---|---|---|
| | TA 1 | TA 2 | TA 3 | TA 4 | TA 5 | TA 6 |
| Cement CEM I 52.5 R | 38 | 38 | 38 | 38 | 35 | 38 |
| Cement CEM I 42.5 R | | | | | | |
| Ground limestone 0.1 mm | 5 | 5 | 5 | 5 | 10 | 5 |
| Limestone sand | | | | | | |
| 0.1-0.7 mm | | | | | | |
| Silica sand | 57 | 57 | 57 | 57 | 55 | 57 |
| 0.1-0.5 mm | | | | | | |
| VINNAPAS ® 5028 E | | | | 5 | 5 | 1 |
| CE | 0.3 | 0.35 | 0.4 | 0.4 | 0.4 | 0.32 |
| SE 1 | | | | | 0.06 | 0.064 |
| Water | 25 | 25 | 25 | 30 | 30 | 26 |

| | Test mixture | | | | |
|---|---|---|---|---|---|
| | TA 7 | TA 8 | TA 9 | CTIS 1 | CTIS 2 |
| Cement CEM I 52.5 R | | 38 | 38 | | |
| Cement CEM I 42.5 R | 30 | | | 20 | 20 |
| Ground limestone 0.1 mm | 5 | 5 | 5 | 20 | 20 |
| Limestone sand | | | | 60 | 60 |
| 0.1-0.7 mm | | | | | |
| Silica sand | 65 | 57 | 57 | | |
| 0.1-0.5 mm | | | | | |
| VINNAPAS ® 5028 E | | 5 | 1 | 1.5 | 1.5 |
| CE | 0.35 | 0.4 | 0.32 | 0.15 | 0.15 |
| SE 1 | | | | | 0.03 |
| Water | 30 | 27.5 | 26 | 21 | 23 |

Test Methods for Tile Adhesives

Open time was determined in accordance with ISO 13007 and DIN EN 1346.

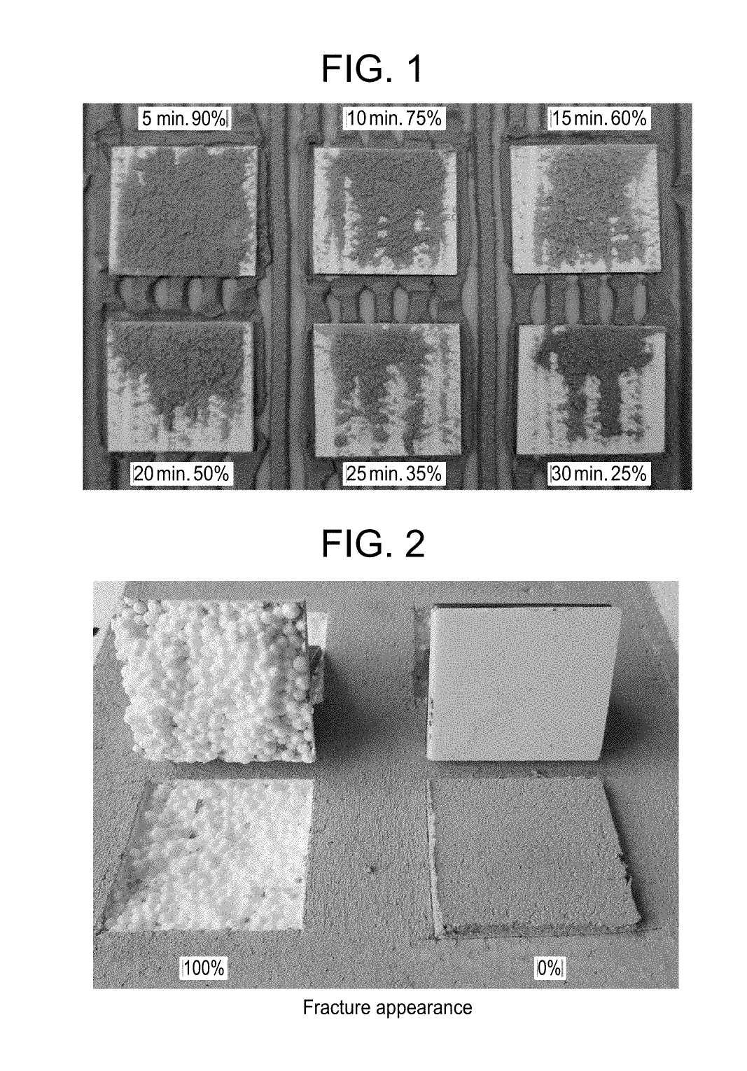

The wetting was measured by laying a stoneware tile (5×5 cm) into the mortar bed (applied in accordance with ISO 13007) every 5 minutes, loading it with 2 kg for 30 seconds and then taking it from the mortar bed. The wetting of the rear side of the tile was reported in %. FIG. 1 shows how the wetting was measured.

Test Methods for CTISs

The wetting was measured by applying a mortar bed having a thickness of 0.5 cm to a plate of expanded polystyrene (EPS) and laying a glazed stoneware tile (5×5 cm²) with the glazed side down into the mortar bed every 5 minutes, loading it with 0.5 kg for 30 seconds and then taking it from the mortar bed. The wetting of the rear side of the tile is reported in %.

The adhesion was measured by applying a mortar bed having a thickness of 0.5 cm to an EPS plate and, after 30 minutes, laying a glazed stoneware tile (5×5 cm²) with the glazed side down into the mortar bed every 10 minutes and loading it with 0.5 kg for 30 seconds. After 7 days, the adhesive pull strength was determined. The adhesive pull strength in N/mm² and the fracture appearance in % are reported. FIG. 2 shows how the adhesion and pullout are evaluated.

TABLE 3
Results of wetting [%] of tile adhesives with unmodified
CE 2 (products No. 1 and 2) and commercial products

| | Experiment number | | | |
|---|---|---|---|---|
| | | 2 | 3 | |
| | 1 | (CULMINAL ® | WALOCEL ® | 4 |
| Product No. | 1 | MHPC 20000 S | Xact 12-01-E | 2 |
| Test mixture | TA 1 | TA 1 | TA 1 | TA 1 |
| Wetting 5 minutes | 80% | 95% | 100% | 100% |
| Wetting 10 minutes | 45% | 40% | 80% | 100% |
| Wetting 15 minutes | 35% | 25% | 40% | 55% |

Experiment number

| | 5 | 6 | 7 | 8 |
|---|---|---|---|---|
| Product No. | 1 | 2 | 1 | 2 |
| Test mixture | TA 2 | TA 2 | TA 3 | TA 3 |
| Wetting 5 minutes | 75% | 95% | 80% | 100% |
| Wetting 10 minutes | 40% | 90% | 40% | 95% |
| Wetting 15 minutes | 35% | 55% | 40% | 55% |

The comparative product No. 1 displayed wetting of about 80% after 5 minutes, and about 40% after 1.0 minutes (Experiments No. 1, 5 and 7).

The competitive product CULMINAL® MHPC 20000 S displayed wetting of 95% after 5 minutes, and about 40% after 10 minutes (Experiment No. 2) and WALOCEL® Xact 12-01-E displayed wetting of 100% after 5 minutes, and 80% after 10 minutes (Experiment No. 3).

Surprisingly, the inventive product No. 2 displayed significantly greater wetting. It displayed wetting of virtually 100% after 5 minutes, and about 95% after 10 minutes (Experiments No. 4, 6 and 8).

TABLE 4
Results of wetting [%] of tile adhesives with modified CE
2 (products No. 3, 4, 5. 10 and 20) and commercial products

| | Experiment number | | |
|---|---|---|---|
| | | 10 | 11 |
| | 9 | METHOCEL ® | WALOCEL ® |
| Product No. | 3 | 327 | Xact 13-70-E |
| Test mixture | TA 4 | TA 8 | TA 4 |
| Wetting 10 minutes | 90% | 90% | 100% |
| Wetting 15 minutes | 85% | 65% | 95% |
| Wetting 20 minutes | 60% | 35% | 75% |

Experiment number

| | 12 | 13 | 14 | 15 |
|---|---|---|---|---|
| Product No. | 4 | 5 | 10 | 20 |
| Test mixture | TA 4 | TA 4 | TA 4 | TA 4 |
| Wetting 10 minutes | 95% | 100% | 95% | 90% |
| Wetting 15 minutes | 90% | 100% | 90% | 70% |
| Wetting 20 minutes | 85% | 90% | 85% | 40% |

Product No. 3 displayed wetting of 85% after 15 minutes, and 60% after 20 minutes (Experiment No. 9).

The comparative product No. 20 displayed wetting of 70% after 15 minutes, and 40% after 20 minutes (Experiment No. 15).

The commercial product METHOCEL® 327 displayed wetting of 65% after 15 minutes, and 35% after 20 minutes (Experiment No. 10), and WALOCEL® Xact 13-70-E displays wetting of 95% after 15 minutes, and 75% after 20 minutes (Experiment No. 11).

Surprisingly, the inventive products No. 4, No. 5 and No. 10 displayed greater wetting.

Product No. 4 displayed wetting of 90% after 15 minutes, and 85% after 20 minutes (Experiment No. 12); product No. 5 displayed wetting of 100% after 15 minutes, and 90% after 20 minutes (Experiment No. 13), and product No. 10 displayed wetting of 90% after 15 minutes, and 85% after 20 minutes (Experiment No. 14).

TABLE 5
Results of wetting [%] of tile adhesives with
modified CE 1 (products No. 3, 4, 5, 9 and 16)

Experiment number

| | 16 | 17 |
|---|---|---|
| Product No. | 11 | 12 |
| Test mixture | TA 5 | TA 5 |
| Wetting 10 minutes | 90% | 90% |
| Wetting 15 minutes | 80% | 90% |
| Wetting 20 minutes | 70% | 80% |
| Wetting 25 minutes | 60% | 80% |
| Wetting 30 minutes | 50% | 70% |

Product No. 11 displayed wetting of 60% after 25 minutes, and 50% after 30 minutes (Experiment No. 16).

Surprisingly, the inventive product No. 12 displayed significantly greater wetting. It displayed wetting of 80% after 25 minutes, and 70% after 30 minutes (Experiment No. 17).

TABLE 6
Results of wetting [%] of tile adhesives with modified CE
3 (products No. 3, 4, 5, 9 and 16) and commercial products

| | Experiment number | | | | |
|---|---|---|---|---|---|
| | | 19 | 20 | | |
| | | CULMINAL ® | WALOCEL ® | | |
| | 18 | Plus 2060 | MKX 45000 | 21 | 22 |
| Product No. | 13 | PF | PF 20 L | 14 | 18 |
| Test mixture | TA 6 | TA | TA 9 | TA 6 | TA 6 |
| Wetting 10 | 80% | 100% | 85% | 100% | 80% |
| minutes | | | | | |
| Wetting 15 | 70% | 95% | 75% | 100% | 70% |
| minutes | | | | | |
| Wetting 20 | 30% | 75% | 65% | 90% | 40% |
| minutes | | | | | |
| Wetting 25 | 10% | 70% | 35% | 85% | 30% |
| minutes | | | | | |

The comparative product No. 13 displayed wetting of 70% after 15 minutes, and 30% after 20 minutes (Experiment No. 18).

The comparative product No. 18 displayed wetting of 70% after 15 minutes, and 40% after 20 minutes (Experiment No. 22), comparatively the same results as comparative product No. 13.

The commercial product CULMINAL® Plus 2060 PF displayed wetting of 95% after 15 minutes, and 75% after 20 minutes (Experiment No. 19), and WALOCEL® MKX 45000 PF 20 L displayed wetting of 75% after 15 minutes, and 65% after 20 minutes (Experiment No. 20).

Surprisingly, the inventive product No. 14 displayed significantly greater wetting. It displayed wetting of 100% after 15 minutes, and 90% after 20 minutes (Experiment No. 21).

TABLE 7
Results of wetting [%] of tile adhesives with product No. 6-9

Experiment number

| | 23 | 24 | 25 | 26 |
|---|---|---|---|---|
| Product No. | 6 | 7 | 8 | 9 |
| Test mixture | TA 4 | TA 4 | TA 4 | TA 4 |
| Wetting 10 minutes | 95% | 100% | 100% | 100% |
| Wetting 15 minutes | 90% | 95% | 90% | 100% |
| Wetting 20 minutes | 70% | 85% | 75% | 90% |

The comparative product No. 6 displayed wetting of 90% after 15 minutes, and 70% after 20 minutes (Experiment No. 23).

Surprisingly, the inventive product No. 7 displayed significantly greater wetting. It displayed wetting of 95% after 15 minutes, and 85% after 20 minutes (Experiment No. 24).

The comparative product No. 8 displayed wetting of 90% after 15 minutes, and 75% after 20 minutes (Experiment No. 25).

Surprisingly, the inventive product No. 9 displayed significantly greater wetting. It displayed wetting of 100% after 15 minutes, and 90% after 20 minutes (Experiment No. 26).

TABLE 8
Results of the open time in accordance with EN 1346 [N/mm²] of
tile adhesives with modified CE 2 (products No. 3, 4, 10 and 20)

| | Experiment number | | | |
|---|---|---|---|---|
| | 27 | 28 | 29 | 30 |
| Product No. | 3 | 4 | 10 | 20 |
| Antifoam | | 5% E1 | 5% E3 | 10% E2 |
| Test mixture | TA 4 | TA 4 | TA 4 | TA 4 |
| Adhesive pull strength after | 1.38 | 1.69 | 1.92 | 1.11 |
| 20 minutes | N/mm² | N/mm² | N/mm² | N/mm² |
| Adhesive pull strength after | 0.87 | 1.34 | 1.29 | 0.70 |
| 30 minutes | N/mm² | N/mm² | N/mm² | N/mm² |

The comparative product No. 3 displayed an adhesive pull strength of 1.38 N/mm² after 20 minutes, and 0.87 N/mm² after 30 minutes (Experiment No. 27).

The comparative product No. 20 displayed an adhesive pull strength of 1.11 N/mm² after 20 minutes, and 0.70 N/mm² after 30 minutes (Experiment No. 30).

Surprisingly, the inventive products No. 4 and No. 10 displayed greater adhesive pull strengths.

Product No. 4 gave 1.69 N/mm² after 20 minutes, and 1.38 N/mm² after 30 minutes (Experiment No. 28).

Product No. 10 gave 1.92 N/mm² after 20 minutes, and 1.29 N/mm² after 30 minutes (Experiment No. 29).

The inventive products No. 4 and No. 10 displayed greater adhesive pull strengths of 20-80%.

TABLE 9
Results of the open time in accordance with EN 1346 [N/mm²] of
tile adhesives with modified CE 3 (products No. 13, 19 and 20)

| | Experiment number | | |
|---|---|---|---|
| | 31 | 32 | 33 |
| Product No. | 13 | 19 | 20 |
| Test mixture | TA 6 | TA 6 | TA 9 |
| Adhesive pull strength after 20 minutes | 0.59 | 0.66 | 0.46 |
| | N/mm² | N/mm² | N/mm² |
| Adhesive pull strength after 30 minutes | 0.17 | 0.51 | 0.23 |
| | N/mm² | N/mm² | N/mm² |

Experiments No. 31 and 33 show that the open time was comparable to the comparative products No. 13 and No. 20 and similar adhesive pull strengths were achieved after 30 minutes, namely 0.17 N/mm² and 0.23 N/mm² respectively.

It was surprisingly found that the inventive product No. 19 (Experiment No. 32) displayed a significantly higher adhesive pull strength, namely 0.51 N/mm² after 30 minutes, which is from 2 to 3 times higher than the comparative products.

TABLE 10
Results of wetting [%] of CTIS renders with
modified CE 1 (products No. 15 and 16)

Experiment number

| | 34 | 35 |
|---|---|---|
| Product No. | 15 | 16 |
| Test mixture | CTIS1 | CTIS1 |
| Wetting 15 minutes | 100% | 100% |
| Wetting 20 minutes | 70% | 85% |
| Wetting 25 minutes | 10% | 30% |
| Wetting 30 minutes | 0% | 20% |

The comparative product No. 15 displayed wetting of 10% after 25 minutes, and 0% after 30 minutes (Experiment No. 34).

Surprisingly, the inventive product No. 16 displayed significantly greater wetting. It displayed wetting of 30% after 25 minutes, and 20% after 30 minutes (Experiment No. 35).

TABLE 11
Results of wetting [%] of CTIS renders with
modified CE 3 (products No. 13 and 19)

Experiment number

| | 36 | 37 |
|---|---|---|
| Product No. | 13 | 19 |
| Test mixture | CTIS2 | CTIS2 |
| Wetting 20 minutes | 100% | 100% |
| Wetting 25 minutes | 90% | 100% |
| Wetting 30 minutes | 50% | 100% |

The comparative product No. 13 displayed wetting of 90% after 25 minutes, and 50% after 30 minutes (Experiment No. 36).

Surprisingly, the inventive product No. 19 displayed significantly greater wetting. It displayed wetting of 100% after 25 minutes, and likewise 100% after 30 minutes (Experiment No. 37).

TABLE 12
Results of the adhesive pull strength [N/mm²] of CTIS
renders with modified CE 3 (products No. 13 und 19)

Experiment number

| | 38 | 39 |
|---|---|---|
| Cellulose ether | 13 | 19 |
| Test mixture | CTIS2 | CTIS2 |
| after 30 minutes | 0.12 N/mm² | 0.09 N/mm² |
| | 100% EPS pullout | 100% EPS pullout |
| after 40 minutes | 0.06 N/mm² | 0.11 N/mm² |
| | 0% EPS pullout | 100% EPS pullout |
| after 50 minutes | 0 N/mm² | 0.09 N/mm² |
| | 0% EPS pullout | 100% EPS pullout |

The comparative product No. 13 displayed an adhesive pull strength of 0.06 N/mm² and 0% EPS pullout after 40 minutes, and no adhesive pull strength and no EPS pullout after 50 minutes (Experiment No. 38).

The inventive product No. 19 displayed an adhesive pull strength of 0.11 N/mm² and 100% EPS pullout after 40 minutes, and an adhesive pull strength of 0.09 N/mm² and 100% EPS pullout after 50 minutes (Experiment No. 39). It was processable for a significantly longer time.

That which is claimed:

1. A method of increasing the open time and wettability of cement-based mortar comprising
incorporating at least one liquid antifoam into cellulose ether to form a compound,
mixing the anti-foamed cellulose ether compound into a mortar,
wherein said mortar is (i) cement-based tile adhesive having increased open time and improved wetting; (ii) cement render having increased processing time; or (iii) cement-based renders in composite thermal insulation systems having increased processing time.

2. The method according to claim 1, wherein the blending step comprises either spraying the liquid antifoam onto the cellulose ether or kneading the liquid antifoam into the cellulose ether.

3. The method according to claim 2, wherein the blending step comprises kneading the liquid antifoam into the cellulose ether.

4. The method according to claim 1, wherein the cellulose ether is hydroxyethyl cellulose, hydroxypropyl cellulose, methyl cellulose, methyl hydroxypropyl cellulose, methyl hydroxyethyl cellulose, ethyl hydroxyethyl cellulose, methyl ethyl hydroxyethyl cellulose, carboxymethyl cellulose, carboxymethyl hydroxyethyl cellulose, carboxymethyl hydroxypropyl cellulose, sulfoethyl methyl hydroxyethyl cellulose, or sulfoethyl methyl hydroxypropyl cellulose.

5. The method according to claim 4, wherein the methyl cellulose has a DS_{methyl} of from 1.4 to 2.2; the methyl hydroxypropyl cellulose has a DS_{methyl} of from 1.2 to 2.2 and an MS_{hydroxypropyl} of from 0.1 to 1.0; the methyl hydroxyethyl cellulose has a DS_{methyl} of from 1.2 to 2.2 and an MS_{hydroxyethyl} of from 0.05 to 0.4; the hydroxyethyl cellulose has an MS_{hydroxyethyl} Of from 1.2 to 4.0; the ethyl hydroxyethyl cellulose has a DS_{ethyl} of from 0.5 to 1.5 and an MS_{hydroxyethyl} of from 1.5 to 3.5; the methyl ethyl hydroxyethyl cellulose has a DS_{methyl} of from 0.2 to 2.0, a DS_{ethyl} of from 0.05 to 1.5 and an MS_{hydroxyethyl} of from 0.2 to 3.5; the carboxymethyl cellulose has a DS_{carboxymethyl} of from 0.4 to 1.0; the carboxymethyl hydroxyethyl cellulose has a DS_{carboxymethyl} of from 0.1 to 1.0 and an MS_{hydroxyethyl} of from 0.8 to 3.5; the carboxymethyl hydroxypropyl cellulose has a DS_{carboxymethyl} of from 0.1 to 1.0 and an MS_{hydroxypropyl} of from 0.8 to 3.3; the sulfoethyl methyl hydroxyethyl cellulose has a DS_{sulfoethyl} of from 0.005 to 0.01, a DS_{methyl} of from 0.2 to 2.0 and an MS_{hydroxyethyl} of from 0.1 to 0.3; or the sulfoethyl methyl hydroxypropyl cellulose has a DS_{sulfoethyl} of from 0.005 to 0.01, a DS_{methyl} of from 0.2 to 2.0 and an MS_{hydroxypropyl} of from 0.1 to 0.3.

6. The method according to claim 5, wherein the methyl cellulose (MC) has said DS_{methyl} of from 1.6 to 2.0; the methyl hydroxypropyl cellulose has said DS_{methyl} of from 1.3 to 2.0 and said MS_{hydroxypropyl} of from 0.15 to 0.7; the methyl hydroxyethyl cellulose has said DS_{methyl} of from 1.4 to 1.9 and said MS_{hydroxyethyl} of from 0.1 to 0.35; and said hydroxyethyl cellulose has said MS_{hydroxyethyl} of from 1.6 to 3.5.

7. The method according to claim 1, wherein the cellulose ether has an average degree of polymerization DPw of from 10 to 5000.

8. The method according to claim 1, wherein the cellulose ether has a viscosity of from 1 to 20 000 mPa s, measured using a Brookfield RV, 20 rpm, in water of 20° C. and 20° dH, where the viscosity is measured at different concentrations of the cellulose ether: viscosity <150 mPa s: 4.75% by weight atro; viscosity from 150 to 250 mPa s: 2.85% by weight atro; viscosity from 250 to 34 000 mPa s: 1.9% by weight atro; viscosity from 4000 to 20 000 mPa s: 1.0% by weight atro.

9. The method according to claim 8, wherein the viscosity of the cellulose ether is from 100 to 15 000 mPa s.

10. The method according to claim 1, wherein the cellulose ether has a moisture content of from 0 to 15% by weight.

11. The method according to claim 1, wherein the cellulose ether compound with liquid antifoam is present in powder form and the powder particles are smaller than 1000 μm, measured using an air jet sieve.

12. The method according to claim 1, wherein the liquid antifoam is a compound based on oxyalkylene, based on silicone, alcohol, mineral oil, based on fatty acids, fatty alcohol alkoxylate and fatty acid esters or a combination thereof.

13. The method according to claim 1, wherein the liquid antifoam is a compound based on fatty alcohol alkoxylates, fatty acid esters or combinations thereof.

14. The method according to claim 1, wherein the compound additionally contains at least one nonionic, anionic or cationic polyacrylamide (PAA).

15. The method according to claim 14, wherein the polyacrylamide has a molar mass of more than 5 million and a particle size of less than 1 mm.

16. The method according to claim 1, wherein the at least one liquid antifoam is present in the compound in a proportion of from 0.5 to 15% by weight, based on the total weight of the dry compound.

17. The method according to claim 16, wherein the at least one liquid antifoam is present in the compound in a proportion of from 0.7 to 10% by weight, based on the total weight of the dry compound.

18. An anti-foamed cellulose ether compound comprising (i) cellulose ether, (ii) at least one liquid antifoam, and (iii) optional nonionic, anionic or cationic polyacrylamide,
wherein the anti-foamed cellulose ether compound is in powder form and the powder particles are smaller than 1000 μm, measured using an air jet sieve.

19. The anti-foamed cellulose ether according to claim 18, wherein the compound liquid antifoam is selected from fatty alcohol alkoxylates, fatty acid esters or combinations thereof.

20. A dry mortar comprising the compound of claim 18 in a proportion of from 0.02 to 1% by weight, based on the total weight of the dry mortar.
